(19) United States
(12) Patent Application Publication
(10) Pub. No.: US 2023/0349230 A1
(43) Pub. Date: Nov. 2, 2023

(54) RETRACTABLE WINDOW SCREEN

(71) Applicants: Brad Alan, St. Clair Shores, MI (US); Elizabeth Allen, St. Clair Shores, MI (US)

(72) Inventors: Brad Alan, St. Clair Shores, MI (US); Elizabeth Allen, St. Clair Shores, MI (US)

(21) Appl. No.: 18/219,711

(22) Filed: Jul. 10, 2023

Related U.S. Application Data
(60) Provisional application No. 63/473,959, filed on Jul. 11, 2022.

(51) Int. Cl. E06B 9/54; E06B 3/38

(52) U.S. Cl. CPC E06B 9/54; E06B 3/38; E06B 2009/528

(57) ABSTRACT

The window assembly of the present invention includes a window frame and window sash rotatable relative to the window frame between a closed position and an open position. In the closed position, the window sash is positioned parallel to the window frame. In the open position, a space is defined between the bottom edges of the window frame and the window sash, and the space defined between the side edges of the window frame and the window sash. A window screen is connected to the two side edges and the bottom edge of the window sash, the two side edges and the bottom edge of the window frame. The window screen is configured to extend in the space. The viewer can have a clear view out of the window assembly without the unsightliness, distortion, or sunlight blockage that is caused by conventional “always visible” window screens.

### CROSS-REFERENCE TO RELATED APPLICATIONS

The present application hereby claims priority to and incorporates by reference the entirety of the disclosures of the provisional application No. 63/473,959 entitled “RETRACTABLE WINDOW SCREEN TO PROVIDE CLEAR VIEW” filed on Jul. 11, 2022.

### TECHNICAL FIELD

The present invention relates to window screens, and more particularly, the present invention relates to a retractable window screen that is at least partially concealed when the window is closed.

### BACKGROUND

Window screens typically serve the purpose of preventing insects, leaves, debris, bugs, and like from entering a premise through a window while allowing air to flow through the window. Generally, window screens have mesh-like net structures made of a material such as but not limited to: metal, fiberglass, plastic, nylon, and so on. The window screens could be permanently installed on a window frame. Further, window screens could be removably attached to a window frame.

Generally, conventional window screens are positioned parallel to the glass pane of the window, which at least partially obstructs the view of a viewer looking through the window. Further, the window screens have a mesh-like net structure and thus, the window screens produce a somewhat aesthetically unpleasing effect on the eyes of a viewer. Further, unsightliness, distortion, or sunlight blockage are caused by conventional “always visible” window screens.

A number of solutions exist in prior art related to problems associated with conventional window screens. For instance, KR20180025549A discloses a screen for a hinged window and, more specifically, relates to a screen for a hinged window, which can perfectly prevent harmful insects such as mosquitoes or the like from being introduced by preventing the screen from being opened when opening and closing the hinged window. In an embodiment, a roll screen screening net is installed in the bottom sealing portion of the screen.

U.S. Pat. No. 4,969,291A discloses a window unit, comprising a frame, a sash mounted in the frame for movement between a closed position adjacent to the frame to an open position in which a space is defined between the sash and the frame, a recess in the frame adjacent the sash, and screen means attached to the sash and dimensioned to fill the space when the sash is in the open position.

CN213510180U discloses an outward-opening top-hung window, which relates to the field of doors and windows and comprises a window cabinet, three screen boxes are fixedly connected to the two sides and the bottom of the interior of the window cabinet through bolts, a spring kit is fixedly arranged in the center of the interior of each screen box, and a tail plug is fixedly connected to the top end of each spring kit. The outer wall of the spring sleeve is connected with a reel. According to the outward-opening top-hung window, the screen window can be unfolded and folded along with opening and closing of the window through the screen, the screen window pull frame and the screen box, an additional operation is not needed, time is saved, ventilation is guaranteed, meanwhile, mosquitoes can be effectively prevented from entering a room, and the outward-opening top-hung window is convenient to use and high in practicability.

The prior art solutions related to window screens have design flaws and are inefficient, uneconomical, impractical, and complex in nature. There is a need for an effective and efficient solution that solves the aforementioned problems of existing prior art solutions by providing a new and improved window assembly.

### SUMMARY

The present disclosure overcomes the drawbacks of the existing devices by providing a window assembly that comprises a window frame comprising a top edge, two side edges, and a bottom edge; a window sash comprising a top edge, two side edges, and a bottom edge; wherein the top edge of the window sash is rotatable relative to the top edge of the window frame between a closed position and an open position, wherein in the closed position, the window sash is positioned substantially parallel to the window frame; wherein in the open position, a space is defined between the bottom edge of the window frame and the bottom edge of the window sash, and the space is further defined between each side edge of the window frame and the corresponding side edge of the window sash. A window screen is connected to the two side edges and the bottom edge of the window sash as well as the two side edges and the bottom edge of the window frame; wherein the window screen is configured to extend in the space. the window screen comprises a bottom coiling cylindrical element connected to at least one of the bottom edge of the window frame and the bottom edge of the window sash, the window screen further comprising two side coiling cylindrical elements wherein each side coiling cylindrical elements connected to at least one of a side edge of the window frame and the corresponding side edge of the window sash, wherein the bottom coiling cylindrical element and the two side coiling cylindrical elements includes a wound up coil for a screen element.

In an embodiment, the window screen is configured to be positioned in a deployed position and a stowed position; wherein in the deployed position, the window sash is positioned in the open position and the window screen extends in the space; and wherein in the stowed position, the window sash is positioned in the closed position and that the window screen is concealed from eyes of a viewer.

In an embodiment, the screen element includes mesh-like openings that allow the air to pass therethrough the screen element while preventing insects, leaves, debris, and bugs from passing through the screen element.

In an embodiment, the hinge element rotatably connects the top edge of the window sash with the top edge of the window frame.

Embodiments of the present invention further disclose a window assembly comprising: a window frame comprising a top edge, two side edges, and a bottom edge; a window sash comprising a top edge, two side edges, and a bottom edge; wherein the top edge of the window sash is rotatable relative to the top edge of the window frame between a closed position and an open position, wherein in the closed position, the window sash is positioned substantially parallel to the window frame; wherein in the open position, a space is defined between the bottom edge of the window frame and the bottom edge of the window sash, and the space is further defined between each side edge of the window frame and the corresponding side edge of the window sash; a window screen connected to the two side edges and the bottom edge of the window sash as well as the two side edges and the bottom edge of the window frame; wherein the window screen is configured to extend in the space; the window screen comprising a bottom pleated screen element connected to the bottom edge of the window frame and the bottom edge of the window sash, the window screen further comprising two side pleated screen elements wherein each side pleated screen element is connected to a side edge of the window frame and the corresponding side edge of the window sash; and wherein the bottom pleated screen element and the two side pleated screen elements comprises a plurality of folding crease lines.

In an embodiment, the window screen is configured to be positioned in a deployed position and a stowed position; wherein in the deployed position, the window sash is positioned in the open position and the window screen extends in the space; and wherein in the stowed position, the window sash is positioned in the closed position and that the window screen is concealed from eyes of the viewer.

In an embodiment, the bottom pleated screen element and the two side pleated screen elements further include mesh-like openings positioned between two adjacent folding crease lines, wherein the mesh-like openings allow the air to pass therethrough the two side pleated screen elements while preventing insects, leaves, debris, bugs from passing through the two side pleated screen elements.

In an embodiment, a hinge element rotatably connects the top edge of the window sash with the top edge of the window frame.

Embodiments of the present invention further disclose a window assembly comprising: a window frame comprising a top edge, two side edges, and a bottom edge; a window sash comprising a top edge, two side edges, and a bottom edge; wherein the top edge of the window sash is rotatable relative to the top edge of the window frame between a closed position and an open position, wherein in the closed position, the window sash is positioned substantially parallel to the window frame; wherein in the open position, a space is defined between the bottom edge of the window frame and the bottom edge of the window sash, and the space is further defined between each side edge of the window frame and the corresponding side edge of the window sash; a window screen connected to the two side edges and the bottom edge of the window sash as well as the two side edges and the bottom edge of the window frame; wherein the window screen is configured to extend in the space; the window screen comprising a bottom coiling cylindrical element connected to at least one of the bottom edge of the window frame and the bottom edge of the window sash, wherein the bottom coiling cylindrical element includes a wound up coil for a screen element; the window screen further comprising two side pleated screen elements wherein each side pleated screen element is connected to a side edge of the window frame and the corresponding side edge of the window sash; wherein the two side pleated screen elements comprises a plurality of folding crease lines.

In an embodiment, the window screen is configured to be positioned in a deployed position and a stowed position; wherein in the deployed position, the window sash is positioned in the open position and the window screen extends in the space; and wherein in the stowed position, the window sash is positioned in the closed position and that the window screen is concealed from eyes of the viewer.

In an embodiment, the screen element includes mesh-like openings that allow the air to pass therethrough the screen element while preventing insects, leaves, debris, and bugs from passing through the screen element.

In an embodiment, the two side pleated screen elements further include mesh-like openings positioned between two adjacent folding crease lines, wherein the mesh-like openings allow the air to pass therethrough the two side pleated screen elements while preventing insects, leaves, debris, bugs from passing through the two side pleated screen elements.

In an embodiment, a hinge element rotatably connects the top edge of the window sash with the top edge of the window frame.

### BRIEF DESCRIPTION OF THE DRAWINGS

A more complete understanding of the present disclosure may be derived by referring to the detailed description and claims when considered in connection with the figures, wherein reference numerals refer to similar elements throughout the figures, and

FIG. 1 illustrates a front-perspective view of a window assembly in a closed position, according to an embodiment of the present invention.

FIG. 2 illustrates a front perspective view of the window assembly of FIG. 1 in an open position.

FIG. 3 illustrates a perspective view of the window screen of the window assembly of FIG. 2 taken along imaginary line X-X.

FIG. 4 illustrates a side view of the window assembly of FIG. 2.

FIG. 5 illustrates a front-perspective view of a window assembly in the closed position, according to another embodiment of the present invention.

FIG. 6 illustrates a front perspective view of the window assembly of FIG. 5 in the open position.

FIG. 7 illustrates a perspective view of the window screen of the window assembly of FIG. 6 taken along imaginary line X-X.

FIG. 8 illustrates a side view of the window assembly of FIG. 6.

FIG. 9 illustrates a front perspective view of the window assembly in the open position, according to yet another embodiment of the present invention.

FIG. 10 illustrates a perspective view of the window screen of the window assembly of FIG. 9 taken along imaginary line X-X.

FIG. 11 illustrates a side view of the window assembly of FIG. 10.

FIG. 12 illustrates a front-perspective view of the window assembly in an open position according to yet another embodiment.

### DETAILED DESCRIPTION

The following description is of exemplary embodiments of the invention only and is not intended to limit the scope, applicability, or configuration of the invention. Rather, the following description is intended to provide a convenient illustration for implementing various embodiments of the invention. As will become apparent, various changes may be made in the function and arrangement of the elements described in these embodiments without departing from the scope of the invention as set forth herein. It should be appreciated that the description herein may be adapted to be employed with alternatively configured devices having different shapes, components, attachment mechanisms, and the like and still fall within the scope of the present invention. Thus, the detailed description herein is presented for purposes of illustration only and not for limitation.

Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

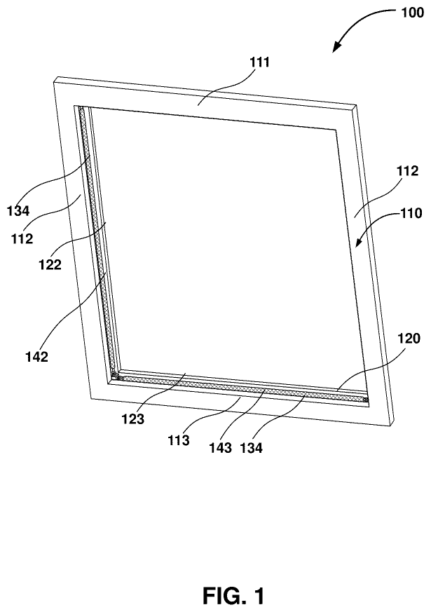

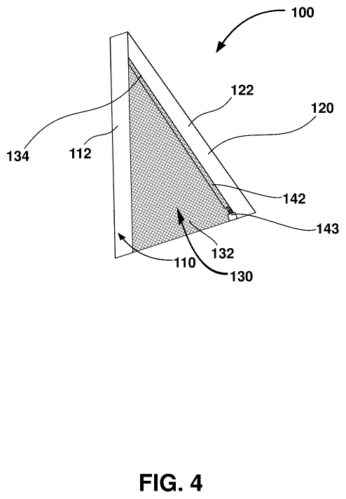

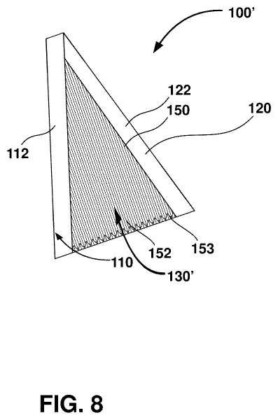

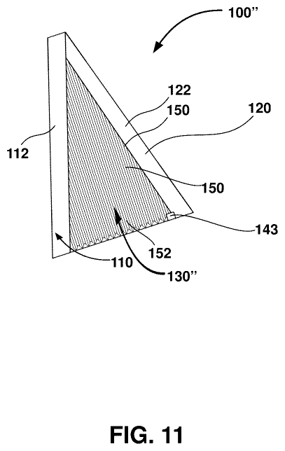

The window assembly will now be described with reference to the accompanying drawings, particularly FIGS. 1-12.

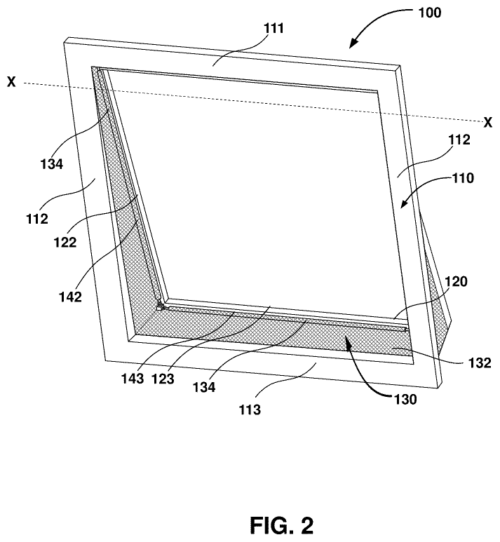

Reference is initially made to FIG. 1 and FIG. 2 that illustrate a front perspective view of a window assembly 100 in a closed position and an open position respectively, according to an embodiment of the present invention. As shown in FIGS. 1-2, the window assembly 100 comprises a window frame 110, a window sash 120, and a window screen 130.

As shown in FIG. 1 and FIG. 2, the window frame 110 comprises a top edge 111, two side edges 112, and a bottom edge 113. A window sash 120 comprises a top edge 121, two side edges 122, and a bottom edge 123. The top edge 121 of the window sash 120 is rotatable relative to the top edge 111 of the window frame 110 between a closed position and an open position by using a hinge element (not shown in figures). In the closed position, the window sash 120 is positioned substantially parallel to the window frame 110. In the open position, a space 128 is defined (formed) between the bottom edge 113 of the window frame 110 and the bottom edge 123 of the window sash 120, and the space 128 is further defined (formed) between each side edge 112 of the window frame 110 and the corresponding side edge 122 of the window sash 120. A window screen 130 is configured to extend into the space 128, which will be further described in greater detail in the below description.

The window screen 130 is configured to be positioned in a deployed position (FIG. 2) and a stowed position (FIG. 1). In the deployed position, the window sash 120 is positioned in the open position and the window screen 130 extends in the space 128; and wherein in the stowed position, the window sash 120 is positioned in the closed position and that the window screen 130 is concealed from eyes of a viewer.

Referring to FIGS. 1-4, the window screen 130 is connected to the two side edges 122 and the bottom edge 123 of the window sash 120 as well as the two side edges 112 and the bottom edge 113 of the window frame 110. In an embodiment as seen in FIGS. 1-4, the window screen 130 comprises a bottom coiling cylindrical element 143 connected to the bottom edge 123 of the window sash 120. Further, the window screen 130 comprises two side coiling cylindrical element 142 wherein each side coiling cylindrical element 142 is connected to a side edge 122 of the window sash 120.

It should be understood that the mounting arrangement of the bottom coiling cylindrical element 143 and the two-side coiling cylindrical elements 142 could be changed. In another embodiment (not shown in figures), the bottom coiling cylindrical element 143 is connected to the bottom edge 113 of the window frame 110. In another embodiment (not shown in figures), each side coiling cylindrical element 142 is connected to a side edge 112 of the window frame 110.

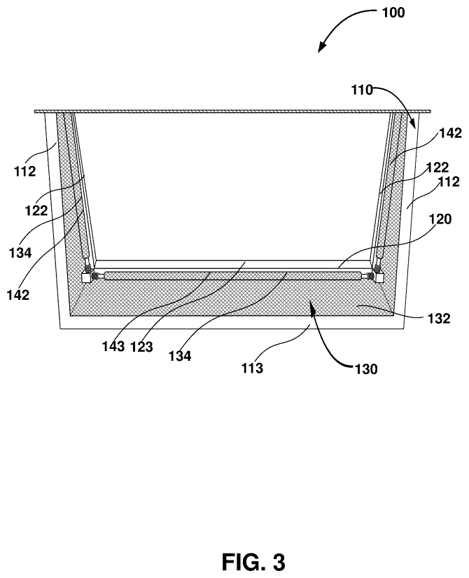

Each of the bottom coiling cylindrical element 143 and the two side coiling cylindrical element 142 includes a wound-up coil 134 for a screen element 132. The screen element 132 has mesh-like openings that allow the air to pass therethrough the screen element 132 while preventing insects, leaves, debris, bugs, and the like from passing through screen element 132. As seen in FIG. 2 and FIG. 3, the wound-up coil 134 includes a torsion spring 134A (not shown in the figures). Thus, the wound-up coil 134 is spring activated in nature thereby enabling the bottom coiling cylindrical element 143 and the two side coiling cylindrical element 142 to be in stowed position in natural state. The screen element 132 is uncoiled from the wound-up coil 134 when the window screen 130 is positioned in a deployed position (FIG. 2) and the screen element 132 is coiled in the wound-up coil 134 when the window screen 130 is positioned in a stowed position (FIG. 1).

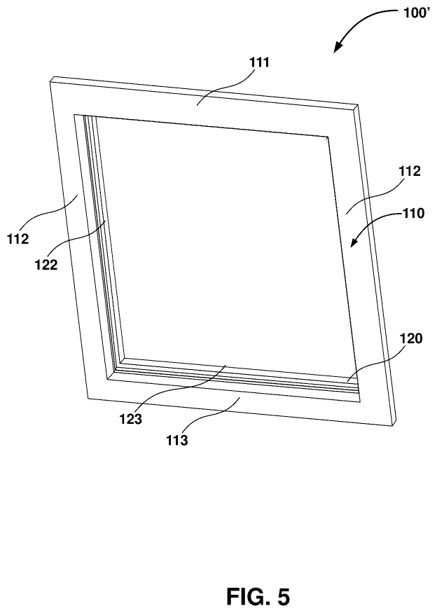

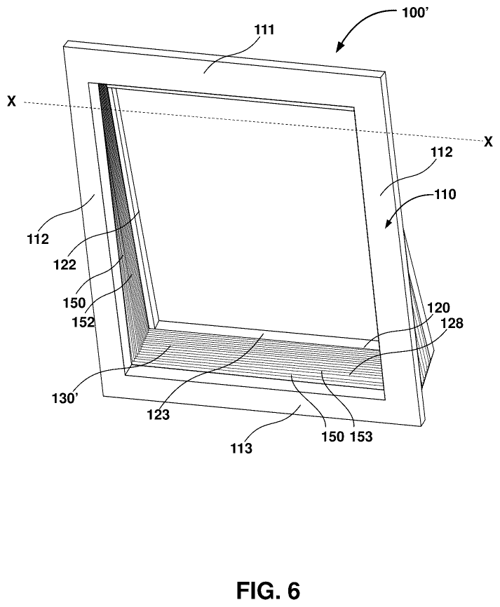

Referring to FIG. 5 and FIG. 6 illustrate a front perspective view of a window assembly 100′ in a closed position and an open position respectively, according to another embodiment of the present invention. The window assembly 100′ is similar to window assembly 100 as seen in FIG. 1 and FIG. 2 except for modifications associated with the window screen. As shown in FIGS. 5-6, the window assembly 100 comprises a window frame 110 earlier used in FIG. 1, a window sash 120 earlier used in FIG. 1, and a window screen 130′.

As shown in FIG. 5 and FIG. 6, the window frame 110 comprises a top edge 111, two side edges 112, and a bottom edge 113. A window sash 120 comprises a top edge 121, two side edges 122, and a bottom edge 123. The top edge 121 of the window sash 120 is rotatable relative to the top edge 111 of the window frame 110 between a closed position and an open position by using a hinge element (not shown in figures). In the closed position, the window sash 120 is positioned substantially parallel to the window frame 110. In the open position, a space 128 is defined (formed) between the bottom edge 113 of the window frame 110 and the bottom edge 123 of the window sash 120, and the space 128 is further defined (formed) between each side edge 112 of the window frame 110 and the corresponding side edge 122 of the window sash 120. A window screen 130′ is configured to extend in space 128, which will be further described in greater detail in the below description.

The window screen 130 is configured to be positioned in a deployed position (FIG. 6) and a stowed position (FIG. 5). In the deployed position, the window sash 120 is positioned in the open position, and the window screen 130′ extends in the space 128; and wherein in the stowed position, the window sash 120 is positioned in the closed position and that the window screen 130′ is concealed from eyes of the viewer.

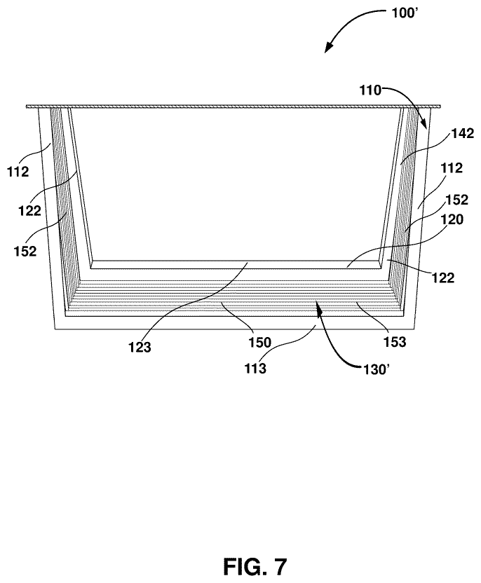

Referring to FIGS. 5-8, the window screen 130′ comprises a bottom pleated screen element 153 connected to the bottom edge 113 of the window frame 110 and the bottom edge 123 of the window sash 120. The window screen 130′ further comprises two side pleated screen elements 152 wherein each side pleated screen element 152 is connected to a side edge 112 of the window frame 110 and the corresponding side edge 122 of the window sash 120. The bottom pleated screen element 153 and the two side pleated screen elements 152 comprises a plurality of folding crease lines 150. As seen in FIG. 6 and FIG. 7, the bottom pleated screen element 153 and the two side pleated screen elements 152 further include mesh-like openings positioned between two adjacent folding crease lines 150. The mesh-like openings allow the air to pass therethrough the bottom pleated screen element 153 and the two side pleated screen elements 152 while preventing insects, leaves, debris, bugs, and like from passing through the bottom pleated screen element 153 and the two side pleated screen elements 152. The plurality of folding crease lines 150 of the bottom pleated screen element 153 and the two side pleated screen elements 152 are in unfolded position when the window screen 130′ is positioned in a deployed position (FIG. 6) and the plurality of folding crease lines 150 of the bottom pleated screen element 153 and the two side pleated screen elements 152 are in the folded position when the window screen 130′ is positioned in a stowed position (FIG. 5).

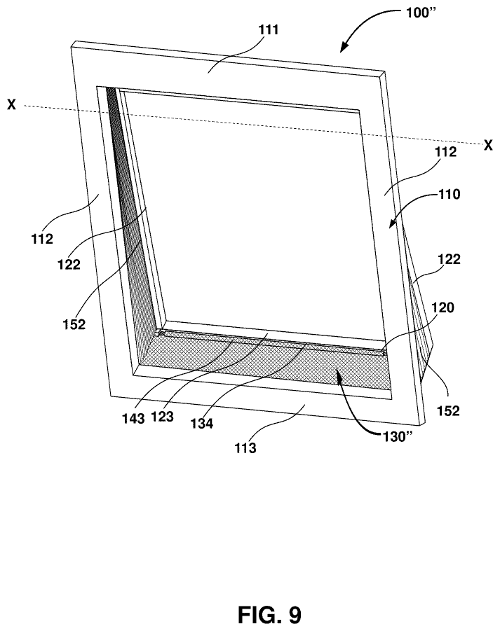

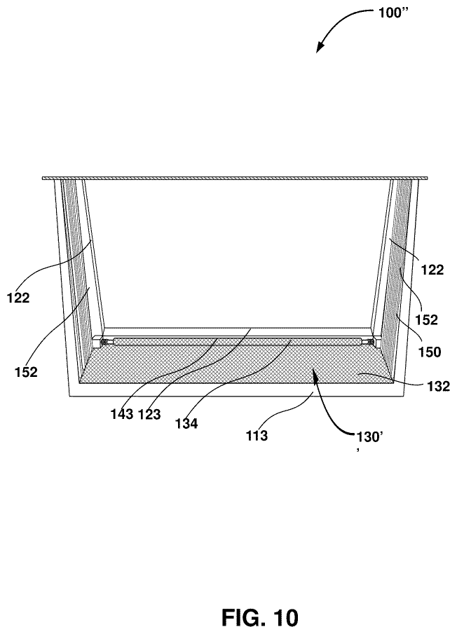

Referring to FIG. 9 that illustrates a front perspective view of a window assembly 100″ in an open position, according to another embodiment of the present invention. The window assembly 100″ is similar to window assembly 100 as seen in FIG. 1 and FIG. 2 except for modifications associated with the window screen. As shown in FIGS. 9-10, the window assembly 100 comprises a window frame 110 earlier used in FIG. 1, a window sash 120 earlier used in FIG. 1, and a window screen 130″.

As shown in FIG. 9 and FIG. 10, the window frame 110 comprises a top edge 111, two side edges 112, and a bottom edge 113. A window sash 120 comprises a top edge 121, two side edges 122, and a bottom edge 123. The top edge 121 of the window sash 120 is rotatable relative to the top edge 111 of the window frame 110 between a closed position and an open position by using a hinge element (not shown in figures). In the closed position, the window sash 120 is positioned substantially parallel to the window frame 110. In the open position, a space 128 is defined (formed) between the bottom edge 113 of the window frame 110 and the bottom edge 123 of the window sash 120, and the space 128 is further defined (formed) between each side edge 112 of the window frame 110 and the corresponding side edge 122 of the window sash 120. A window screen 130″ is configured to extend in space 128, which will be further described in greater detail in the below description.

The window screen 130″ is configured to be positioned in a deployed position (FIG. 9) and a stowed position (not shown in figures). In the deployed position, the window sash 120 is positioned in the open position and the window screen 130″ extends in space 128; and wherein in the stowed position (not shown in figures), the window sash 120 is positioned in the closed position and the window screen 130″ is concealed from eyes of the viewer.

Referring to FIGS. 9-11, the window screen 130″ comprises a bottom coiling cylindrical element 143 connected to at least one of the bottom edge 113 of the window frame 110 and the bottom edge 123 of the window sash 120. The bottom coiling cylindrical element 143 includes a wound-up coil 134 of a screen element 132. The screen element 132 has mesh-like openings that allow the air to pass therethrough the screen element 132 while preventing insects, leaves, debris, bugs, and the like from passing through the screen element 132. As seen in FIG. 9 and FIG. 10, the wound-up coil 134 includes a torsion spring 134A (not shown in figures). Thus, the wound-up coil 134 is spring activated in nature thereby enabling the bottom coiling cylindrical element 143 to be in stowed position in its natural state. The window screen 130″ further comprises two side pleated screen elements 152 wherein each side pleated screen element 152 is connected to a side edge 112 of the window frame 110 and the corresponding side edge 122 of the window sash 120. The two side pleated screen elements 152 comprise a plurality of folding crease lines 150. As seen in FIG. 9 and FIG. 10, the two side pleated screen elements 152 further include mesh-like openings positioned between two adjacent folding crease lines 150. The mesh-like openings allow the air to pass therethrough the two side pleated screen elements 152 while preventing insects, leaves, debris, bugs, and like from passing through the two side pleated screen elements 152. The plurality of folding crease lines 150 of the two side pleated screen elements 152 are in the unfolded position and the screen element 132 is uncoiled from the wound-up coil 134 of the bottom coiling cylindrical element 143 when the window screen 130″ is positioned in a deployed position (FIG. 9) and the plurality of folding crease lines 150 of the two side pleated screen elements 152 are in the folded position and the screen element 132 is coiled in the wound up coil 134 of the bottom coiling cylindrical element 143 when the window screen 130″ is positioned in a stowed position (not shown in figures).

It should be understood that the material of various parts and components of the window assembly (100,100′, 100″) of the present invention is non-limiting and could depend of the requirements of the owner (buyer) of the window assembly (100,100′, 100″). For instance, the material of the screen element 132, the side pleated screen elements 152, and the bottom pleated screen element 153 could include but not limited to: metal, fibreglass, plastic, nylon, and so on.

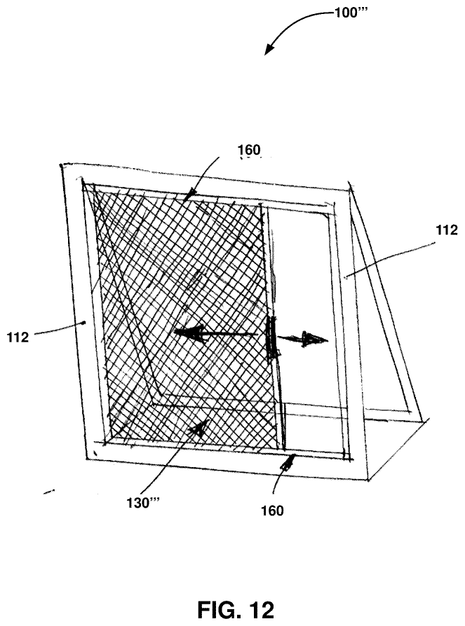

Referring to FIG. 12, in yet another embodiment of the window assembly 100′″ in an open position, the window screen 130′″ is shown configured in the form of a sliding screen. The screen 130′″ covers the entire window extending from one side edge 112 to another side edge of the window when deployed or in use. The window screen is configured to slide along a sliding track 160. The user just can slide the window screen along track to deploy or get rid of the screen 130″. The use of this type of the window assembly may be universal and can be used in all types of windows for example, sliders, casements, awing, and even doors.

The various components, and parts of the various embodiments of the window assembly (100,100′, 100″,100′″) of the present invention is similar and interchangeable. It is obvious to the one skilled in the art that the various components, parts of the window assembly of one embodiment of the present invention could be considered for other embodiments with little or no variation.

Finally, while the present invention has been described above with reference to various exemplary embodiments, many changes, combinations, and modifications may be made to the exemplary embodiments without departing from the scope of the present invention. For example, the various components may be implemented in alternative ways. These alternatives can be suitably selected depending upon the particular application or in consideration of any number of factors associated with the operation of the device. In addition, the techniques described herein may be extended or modified for use with other types of devices. These and other changes or modifications are intended to be included within the scope of the present invention.

What is claimed is:

1. A window assembly (100), comprising:
a window frame (110) comprising a top edge (111), two side edges (112), and a bottom edge (113);
a window sash (120) comprising a top edge (121), two side edges (122), and a bottom edge (123), wherein the top edge (121) of the window sash (120) is rotatable relative to the top edge (111) of the window frame (110) between a closed position and an open position, and wherein in the closed position, the window sash (120) is positioned substantially parallel to the window frame (110);
wherein in the open position, a space (128) is defined between the bottom edge (113) of the window frame (110) and the bottom edge (123) of the window sash (120), and the space (128) is further defined between each side edge (112) of the window frame (110) and the corresponding side edge (122) of the window sash (120);
a window screen (130) connected to the two side edges (122) and the bottom edge (123) of the window sash (120) as well as the two side edges (112) and the bottom edge (113) of the window frame (110); wherein the window screen (130) is configured to extend in the space (128);
wherein the window screen (130) comprising a bottom coiling cylindrical element (143) connected to at least one of the bottom edge (113) of the window frame (110) and the bottom edge (123) of the window sash (120), and wherein the window screen (130) further comprising two side coiling cylindrical elements (142) wherein each of the side coiling cylindrical element (142) is connected to at least one of the side edge (112) of the window frame (110) and the corresponding side edge (122) of the window sash (120); and
wherein the bottom coiling cylindrical element (143) and the two side coiling cylindrical elements (142) includes a wound-up coil (134) for a screen element (132).

2. The window assembly (100) according to claim 1, wherein the window screen (130) is configured to be positioned in a deployed position and a stowed position; wherein in the deployed position, the window sash (120) is positioned in the open position and the window screen (130) extends in the space (128); and wherein in the stowed position, the window sash (120) is positioned in the closed position and that the window screen (130) is concealed from eyes of a viewer.

3. The window assembly (100) according to claim 1, wherein the screen element (132) includes mesh-like openings that allow the air to pass therethrough the screen element (132) while preventing insects, leaves, debris, and bugs from passing through the screen element (132).

4. The window assembly (100) according to claim 1, wherein a hinge element rotatably connects the top edge (121) of the window sash (120) with the top edge (111) of the window frame (110).

5. A window assembly (100′), comprising:
a window frame (110) comprising a top edge (111), two side edges (112), and a bottom edge (113);
a window sash (120) comprising a top edge (121), two side edges (122), and a bottom edge (123); wherein the top edge (121) of the window sash (120) is rotatable relative to the top edge (111) of the window frame (110) between a closed position and an open position,
wherein in the closed position, the window sash (120) is positioned substantially parallel to the window frame (110);
wherein in the open position, a space (128) is defined between the bottom edge (113) of the window frame (110) and the bottom edge (123) of the window sash (120), and the space (128) is further defined between each side edge (112) of the window frame (110) and the corresponding side edge (122) of the window sash (120);
a window screen (130′) connected to the two side edges (122) and the bottom edge (123) of the window sash (120) as well as the two side edges (112) and the bottom edge (113) of the window frame (110); wherein the window screen (130′) is configured to extend in the space (128);
wherein the window screen (130′) comprising a bottom pleated screen element (153) connected to the bottom edge (113) of the window frame (110) and the bottom edge (123) of the window sash (120), and wherein the window screen (130′) further comprising two side pleated screen elements (152) wherein each side pleated screen element (152) is connected to a side edge (112) of the window frame (110) and the corresponding side edge (122) of the window sash (120); and
wherein the bottom pleated screen element (153) and the two side pleated screen elements (152) comprises a plurality of folding crease lines (150).

6. The window assembly (100′) according to claim 5, wherein the window screen (130′) is configured to be positioned in a deployed position and a stowed position; wherein in the deployed position, the window sash (120) is positioned in the open position and the window screen (130′) extends in the space (128); and wherein in the stowed position, the window sash (120) is positioned in the closed position and that the window screen (130′) is concealed from eyes of a viewer.

7. The window assembly (100′) according to claim 5, wherein the bottom pleated screen element (153) and the two side pleated screen elements (152) further include mesh-like openings positioned between two adjacent folding crease lines (150), wherein the mesh-like openings allow the air to pass therethrough the two side pleated screen elements (152) while preventing insects, leaves, debris, bugs from passing through the two side pleated screen elements (152).

8. The window assembly (100′) according to claim 5, wherein a hinge element rotatably connects the top edge (121) of the window sash (120) with the top edge (111) of the window frame (110).

9. A window assembly (100″), comprising:
a window frame (110) comprising a top edge (111), two side edges (112), and a bottom edge (113);
a window sash (120) comprising a top edge (121), two side edges (122), and a bottom edge (123); wherein the top edge (121) of the window sash (120) is rotatable relative to the top edge (111) of the window frame (110) between a closed position and an open position,
wherein in the closed position, the window sash (120) is positioned substantially parallel to the window frame (110);
wherein in the open position, a space (128) is defined between the bottom edge (113) of the window frame (110) and the bottom edge (123) of the window sash (120), and the space (128) is further defined between each side edge (112) of the window frame (110) and the corresponding side edge (122) of the window sash (120);
a window screen (130″) connected to the two side edges (122) and the bottom edge (123) of the window sash (120) as well as the two side edges (112) and the bottom edge (113) of the window frame (110); wherein the window screen (130″) is configured to extend in the space (128);
wherein the window screen (130″) comprising a bottom coiling cylindrical element (143) connected to at least one of the bottom edge (113) of the window frame (110) and the bottom edge (123) of the window sash (120), wherein the bottom coiling cylindrical element (143) includes a wound up coil (134) for a screen element (132);
wherein the window screen (130″) further comprising two side-pleated screen elements (152) wherein each side-pleated screen element (152) is connected to a side edge (112) of the window frame (110) and the corresponding side edge (122) of the window sash (120); and
wherein the two side pleated screen elements (152) comprises a plurality of folding crease lines (150).

10. The window assembly (100″) according to claim 9, wherein the window screen (130″) is configured to be positioned in a deployed position and a stowed position; wherein in the deployed position, the window sash (120) is positioned in the open position and the window screen (130″) extends in the space (128); and wherein in the stowed position, the window sash (120) is positioned in the closed position and that the window screen (130″) is concealed from eyes of a viewer.

11. The window assembly (100″) according to claim 9, wherein the screen element (132) includes mesh-like openings that allow the air to pass therethrough the screen element (132) while preventing insects, leaves, debris, and bugs from passing through the screen element (132).

12. The window assembly (100″) according to claim 9, wherein the two side pleated screen elements (152) further include mesh-like openings positioned between two adjacent folding crease lines (150), wherein the mesh like openings allow the air to pass therethrough the two side pleated screen elements (152) while preventing insects, leaves, debris, bugs from passing through the two side pleated screen elements (152).

13. The window assembly (100) according to claim 9, wherein a hinge element rotatably connects the top edge (121) of the window sash (120) with the top edge (111) of the window frame (110).
